(19) United States
(12) Patent Application Publication
(10) Pub. No.: US 2023/0301487 A1
(43) Pub. Date: Sep. 28, 2023

(54) Golf Shoe Cleaning Assembly

(71) Applicant: Kimiko Miller, Brea, CA (US)

(72) Inventor: Kimiko Miller, Brea, CA (US)

(21) Appl. No.: 17/701,843

(22) Filed: Mar. 23, 2022

(51) Int. Cl. A47L 23/02; B08B 1/00; A47L 23/06; B08B 5/02

(52) U.S. Cl. CPC A47L 23/02; B08B 1/002; A47L 23/06; B08B 5/02

(57) ABSTRACT

A golf shoe cleaning assembly includes an air gun that has an intake and an exhaust. An air pump is positioned within the air gun to urge compressed air outwardly through the exhaust. A heating unit is positioned within the air gun to heat air blown outwardly through the exhaust. A pressure control is movably integrated into the air gun for adjusting an output of the air pump between a minimum output and a maximum output. A heat control is movably integrated into the air gun for adjusting the heating unit between a minimum output and a maximum output. A plurality of brush fittings is provided and a respective one of the brush fittings is insertable into the exhaust of the air gun to receive the air from the air pump thereby facilitating the respective brush fitting to direct the air onto golf shoes for dislodging dirt and debris from the golf shoes.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shoe cleaning devices and more particularly pertains to a new shoe cleaning device for cleaning dirt and debris from golf shoes. The device includes an air gun which as an air pump and a heating unit for blowing heated air. The device includes a plurality of brush fittings and a respective one of the brush fittings is attachable to the air gun. Each of the brush fittings has unique brushing elements with respect to each other thereby facilitating each of the brush fittings dislodge dirt and debris from golf shoes.

### (2) DESCRIPTION OF RELATED ART INCLUDING INFORMATION DISCLOSED UNDER 37 CFR 1.97 AND 1.98

The prior art relates to shoe cleaning devices including a compressed air duster that includes a manually operated air pump and a curved output nozzle. The prior art discloses a toothbrush device that includes an air pump which urges compressed air outwardly through a head of a toothbrush. The prior art discloses a variety of footwear cleaning devices that includes a pair of motorized brushes and a vacuum unit for cleaning footwear. The prior art discloses a footwear cleaner that includes a mat with brushes on the mat and a source of compressed air for cleaning soles of footwear. The prior art discloses a cleaning device that includes a wand that is fluidly attachable to a fluid source and a brush attached to the wand for cleaning objects. The prior art discloses a cleaning nozzle that includes a plurality of air openings and a plurality of bristles positioned adjacent to the air openings.

### BRIEF SUMMARY OF THE INVENTION

An embodiment of the disclosure meets the needs presented above by generally comprising an air gun that has an intake and an exhaust. An air pump is positioned within the air gun to urge compressed air outwardly through the exhaust. A heating unit is positioned within the air gun to heat air blown outwardly through the exhaust. A pressure control is movably integrated into the air gun for adjusting an output of the air pump between a minimum output and a maximum output. A heat control is movably integrated into the air gun for adjusting the heating unit between a minimum output and a maximum output. A plurality of brush fittings is provided and a respective one of the brush fittings is insertable into the exhaust of the air gun to receive the air from the air pump thereby facilitating the respective brush fitting to direct the air onto golf shoes for dislodging dirt and debris from the golf shoes.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of an embodiment of the disclosure showing a third brush fitting attached to an air gun.

FIG. 2 is a top view of an embodiment of the disclosure showing a second brush fitting attached to an air gun.

FIG. 3 is a top view of an embodiment of the disclosure showing a third brush fitting attached to an air gun.

FIG. 4 is a cross sectional view taken along line 4-4 of FIG. 1 of an embodiment of the disclosure.

FIG. 5 is a cross sectional view taken along line 5-5 of FIG. 2 of an embodiment of the disclosure.

FIG. 6 is a cross sectional view taken along line 6-6 of FIG. 3 of an embodiment of the disclosure.

FIG. 7 is a perspective view of a golf shoe cleaning assembly according to embodiment of the disclosure.

FIG. 8 is a perspective in-use view of an embodiment of the disclosure.

FIG. 9 is a perspective view of an alternative embodiment of the disclosure.

FIG. 10 is a left view of an alternative embodiment of the disclosure showing an air gun with a handle section and a barrel section.

### DETAILED DESCRIPTION OF THE INVENTION

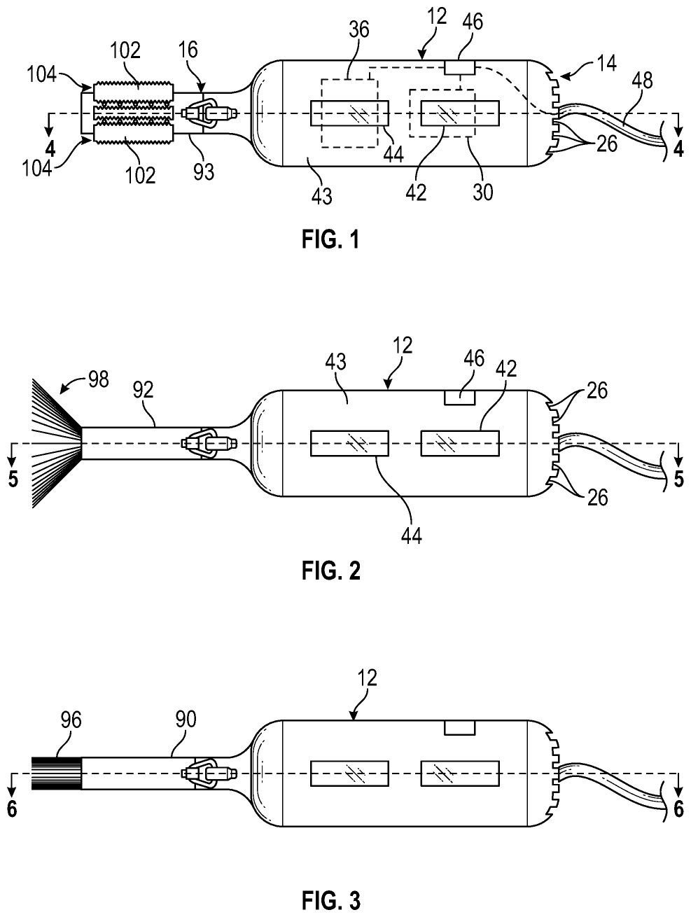

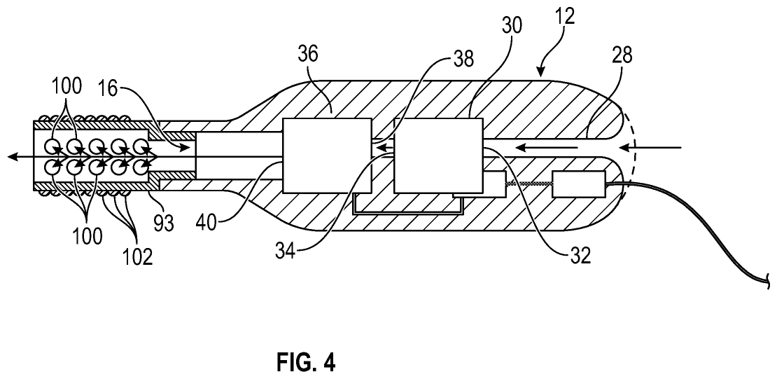

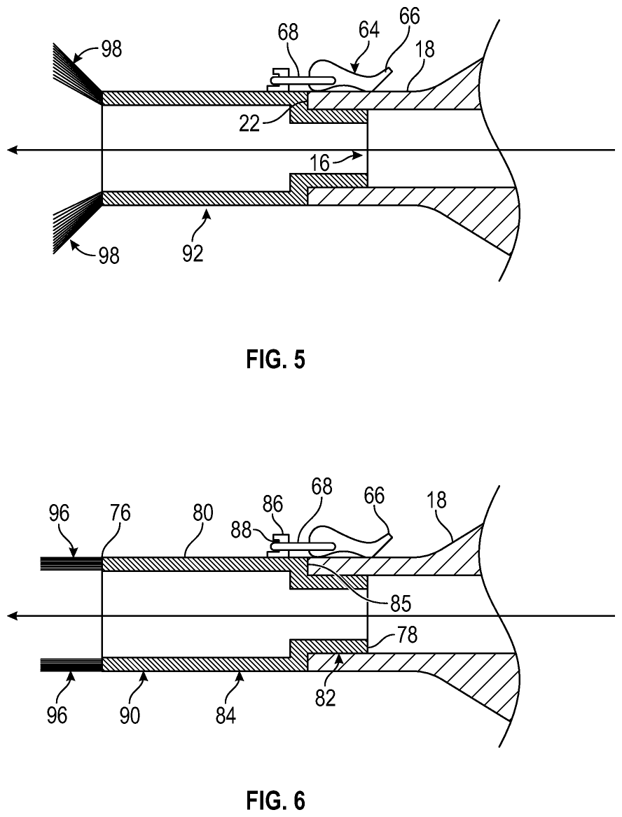

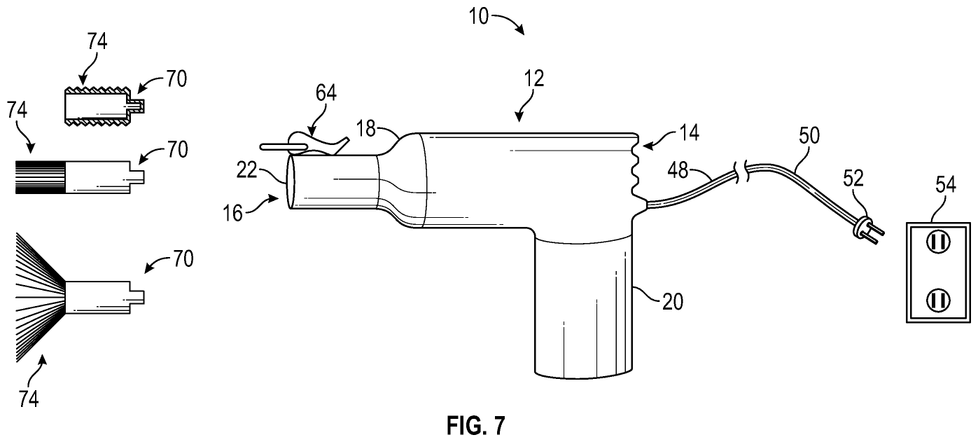

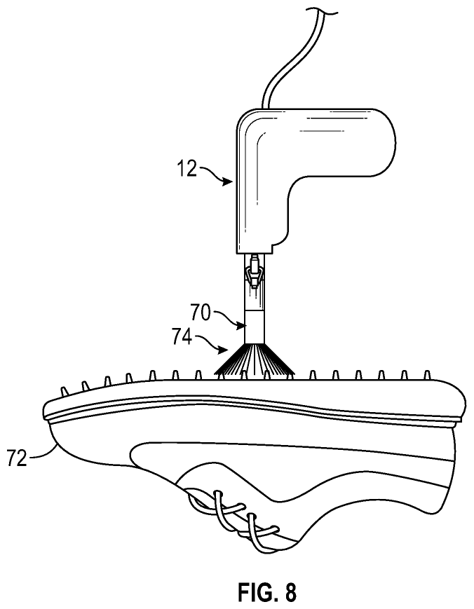

With reference now to the drawings, and in particular to FIGS. 1 through 10 thereof, a new shoe cleaning device embodying the principles and concepts of an embodiment of the disclosure and generally designated by the reference numeral 10 will be described.

As best illustrated in FIGS. 1 through 10, the golf shoe cleaning assembly 10 generally comprises an air gun 12 that has an intake 14 and an exhaust 16. The air gun 12 has a barrel section 18 and a grip section 20, and the barrel section 18 has a distal end 22 with respect to the grip section 20. Furthermore, the distal end 22 is open to define the exhaust 16. The grip section 20 has a back end 24 and the back end 24 has a plurality of air holes 26 each extending into an interior of the grip section 20 to define the intake 14. Additionally, the air gun 12 has a conduit 28 extending between the air holes 26 and the distal end 22 of the barrel section 18.

An air pump 30 is positioned within the air gun 12 to urge compressed air outwardly through the exhaust 16, and the air pump 30 has an input 32 and an outlet 34. The air pump 30 is fluidly coupled to the conduit 28 such that the input 32 is in fluid communication with the plurality of air holes 26 and the output is in fluid communication with the distal end 22 of the barrel section 18. The air pump 30 urges air inwardly through the input 32 and outwardly through the outlet 34 when the air pump 30 is turned on. The air pump 30 may comprise an electric air pump which has an output pressure of at least 50.0 pounds per square inch.

A heating unit 36 is positioned within the air gun 12 and the heating unit 36 is in thermal communication with the exhaust 16 to heat air blown outwardly through the exhaust 16. The heating unit 36 has an input 38 and an outlet 40. Moreover, the input 38 of the heating unit 36 is fluidly coupled to the conduit 28 such that the input 38 of the heating unit 36 is in fluid communication with the outlet 34 of the air pump 30 and the outlet 40 of the heating unit 36 is in fluid communication with the distal end 22 of the barrel section 18. The heating unit 36 heats the air urged outwardly through the outlet 34 of the air pump 30 when the heating unit 36 is turned on. The heating unit 36 may include an electric heating coil that has an operational temperature ranging between approximately 100.0 degrees Fahrenheit and 150.0 degrees Fahrenheit.

A pressure control 42 is movably integrated into the air gun 12 such that the pressure control 42 can be manipulated by a user. The pressure control 42 is in communication with the air pump 30 for adjusting an output of the air pump 30 between a minimum output and a maximum output. The pressure control 42 is electrically coupled to the air pump 30 and the pressure control 42 is positioned on a top side 43 of the grip section 20 of the air gun 12. The pressure control 42 may comprise a switch that is slidably positioned on the air gun 12, a touch pad that is touch sensitive or any other type of electronic control.

A heat control 44 is movably integrated into the air gun 12 such that the heat control 44 can to be manipulated by a user. The heat control 44 is in communication with the heating unit 36 for adjusting the heating unit 36 between a minimum output and a maximum output. The heat control 44 is electrically coupled to the heating unit 36 and the heat control 44 is positioned on the top side 43 of the grip section 20 of the air gun 12. The heat control 44 may comprise a switch that is slidably positioned on the air gun 12, a touch pad that is touch sensitive or any other type of electronic control.

A power control 46 is movably integrated into the air gun 12 such that the power control 46 can be manipulated by a user, and the power control 46 is electrically coupled to each of the air pump 30 and the heat control 44. The power control 46 de-actuates each of the air pump 30 and the heat control 44 when the power control 46 is in an off condition. Conversely, the power control 46 actuates each of the air pump 30 and the heat control 44 when the power control 46 is in an on condition. The power control 46 may comprise a switch, a touch pad or any other type of electronic control. A power cord 48 is coupled to and extends away from the air gun 12 and the power cord 48 is electrically coupled to the power control 46. The power cord 48 has a distal end 50 with respect to the air gun 12 and a male plug 52 is electrically coupled to the distal end 50 of the power cord 48. In this way the male plug 52 can be plugged into a power source 54 comprising a female electrical outlet 34.

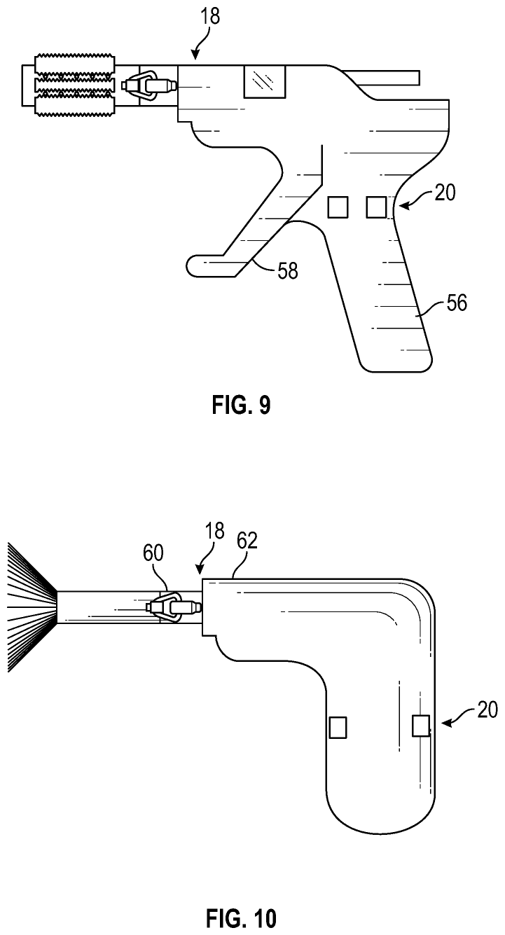

As is most clearly shown in FIG. 9, the grip section 20 may include a handle 56 that is perpendicularly oriented with the barrel section 18 and a leg 58 which angles forwardly from the handle 56. Each of the power control 46 and the pressure control 42 may be positioned on the handle 56. Additionally, the power control 46 may be positioned on the barrel section 18. As is most clearly shown in FIG. 10, the grip section 20 may be perpendicularly oriented with the barrel section 18, and the barrel section 18 may include a primary portion 60 that has a diameter which is less than a diameter of a secondary portion 62. Additionally, the distal end 22 of the barrel section 18 may be associated with the primary portion 60. Each of the power control 46, with pressure control 42 and the heat control 44 may be positioned on the handle 56.

A latch 64 is movably integrated into the air gun 12 and the latch 64 is movable between an engaging position and a releasing position. The latch 64 is positioned on the barrel section 18 of the air gun 12, and the latch 64 includes a lever 66 that is pivotally coupled to the barrel section 18 and a loop 68 is movably coupled to the lever 66. The loop 68 extends outwardly beyond the distal end 22 of the barrel section 18. Furthermore, the loop 68 is urged away from the distal end 22 when the latch 64 is in the releasing position and the loop 68 is urged toward the distal end 22 when the latch 64 is in the engaging position.

A plurality of brush fittings 70 is provided and a respective one of the brush fittings 70 is insertable into the barrel section 18 of the exhaust 16 of the air gun 12 to receive the air from the air pump 30. In this way the respective brush fitting 70 can direct the air onto golf shoes 72 for dislodging dirt and debris from the golf shoes 72. Each of the brush fittings 70 has a unique brushing element 74 with respect to each other to perform a respective cleaning duty. Each of the brush fittings 70 has a first end 76, a second end 78 and an outer wall 80 extending between the first end 76 and the back end 24. Each of the first end 76 and the second end 78 is open and each of the brush fittings 70 is hollow to pass air through the first end 76 and the second end 78. The outer wall 80 has a first portion 82 that has a diameter which is less than diameter of a second portion 84. The first end 76 is associated with the first portion 82 and the second end 78 is associated with the second end 78. The first portion 82 is insertable into the distal end 22 of the barrel section 18 of the air gun 12 having a threshold 85 between the first portion 82 and the second portion 84 abutting the distal end 22 of the barrel section 18.

Each of the brush fittings 70 has an engagement 86 that is coupled to the outer wall 80 and the engagement 86 is positioned adjacent to the threshold 85 between the first portion 82 and the second portion 84. The engagement 86 has a recess 88 integrated therein and the recess 88 in the engagement 86 of a respective brush fitting 70 receives the loop 68 of the latch 64. The loop 68 compresses the threshold of the respective brush fitting 70 against the distal end 22 of the barrel section 18 when the latch 64 is moved into the engaging position for retaining the respective brush fitting 70 in the distal end 22.

The plurality of brush fittings 70 includes a first brush fitting 90, a second brush fitting 92 and a third brush fitting 94. The brushing elements 74 associated with the first brush fitting 90 comprise a plurality of first bristles 96 each extending away from the second end 78 of the first brush fitting 90. The first bristles 96 are spaced apart from each other and are distributed around the second end 78 of the first brush fitting 90. Each of the first bristles 96 is comprised of a resilient material to dislodge dirt and debris from the golf shoes 72. Each of the first bristles 96 extends along a line that is coextensive with an axis extending through the first end 76 and the second of the first brush fitting 90.

The brushing elements 74 associated with the second brush fitting 92 comprise a plurality of second bristles 98 each extending away from the second end 78 of the second brush fitting 92. The second bristles 98 are spaced apart from each other and are distributed around the second end 78 of the second brush fitting 92. Additionally, each of the second bristles 98 is comprised of a bendable material to brush the golf shoes 72 without abrading the golf shoes 72. Each of the second bristles 98 radiates outwardly from the second end 78 of the second brush fitting 92.

The second portion 84 of the outer wall 80 of the third brush fitting 94 has a plurality of air holes 100 each extending into an interior of the third brush fitting 94 to direct air outwardly through the air holes 100. The brushing elements 74 associated with the third brush fitting 94 comprise a plurality of lobes 102 that is each positioned on and extends outwardly from the outer wall 80 associated with the second portion 84 of the outer wall 80 of the third brush fitting 94. The plurality of lobes 102 is arranged into a plurality of rows 104 each extending between the second end 78 of the third brush fitting 94 and the threshold of the third brush fitting 94. Each of the lobes 102 is comprised of a compressible textile material to clean an upper of the golf shoes 72 without abrading the upper of the golf shoes 72.

In use, a respective one of the brush fittings 70 is attached to the air gun 12, depending on the nature of cleaning that is to be performed on the golf shoes 72, and the latch 64 is manipulated to secure the respective brush fitting 70 to the air gun 12. The power control 46 is turned on and each of the pressure control 42 and the heat control 44 is manipulated to adjust the pressure of the air and the temperature of the air. The bushing elements 74 on the respective brush fitting 70 are scrubbed against the golf shoes 72 and the compressed air blows outwardly through the respective brush fitting 70. In this way dirt and debris can be dislodged and scrubbed away from the golf shoes 72.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A golf shoe cleaning assembly for cleaning dirt and debris from golf shoes, said assembly comprising:
an air gun having an intake and an exhaust;
an air pump being positioned within said air gun wherein said air pump is configured to urge compressed air outwardly through said exhaust;
a heating unit being positioned within said air gun, said heating unit being in thermal communication with said exhaust wherein said heating unit is configured to heat air blown outwardly through said exhaust;
a pressure control being movably integrated into said air gun wherein said pressure control is configured to be manipulated by a user, said pressure control being in communication with said air pump for adjusting an output of said air pump between a minimum output and a maximum output;
a heat control being movably integrated into said air gun wherein said heat control is configured to be manipulated by a user, said heat control being in communication with said heating unit for adjusting said heating unit between a minimum output and a maximum output;
a latch being movably integrated into said air gun, said latch being movable between an engaging position and a releasing position; and
a plurality of brush fittings, a respective one of said brush fittings being insertable into said exhaust of said air gun wherein each of said brush fittings is configured to receive the air from said air pump thereby facilitating said respective brush fitting to direct the air onto golf shoes for dislodging dirt and debris from the golf shoes, each of said brush fittings having a unique brushing element with respect to each other wherein said plurality of brush fittings is configured to perform a respective cleaning duty.

2. The assembly according to claim 1, wherein said air gun has a barrel section and a grip section, said barrel section having a distal end with respect to said grip section, said distal end being open to define said exhaust, said grip section having a back end, said back end having a plurality of air holes each extending into an interior of said grip section to define said intake, said air gun having a conduit extending between said air holes and said distal end of said barrel section.

3. The assembly according to claim 2, wherein said air pump has an input and an outlet, said air pump being fluidly coupled to said conduit such that said input is in fluid communication with said plurality of air holes and said output is in fluid communication with said distal end of said barrel section, said air pump urging air inwardly through said input and outwardly through said outlet when said air pump is turned on.

4. The assembly according to claim 3, wherein said heating unit has an input and an outlet, said input of said heating unit being fluidly coupled to said conduit such that said input of said heating unit is in fluid communication with said outlet of said air pump and said outlet of said heating unit is in fluid communication with said distal end of said barrel section, said heating unit heating air urged outwardly through said outlet of said air pump when said heating unit is turned on.

5. The assembly according to claim 2, wherein:
said pressure control is electrically coupled to said air pump, said pressure control being positioned on a top side of said grip section of said air gun;
said heat control is electrically coupled to said heating unit, said heat control being positioned on a top side of said grip section of said air gun;
a power control being movably integrated into said air gun wherein said power control is configured to be manipulated by a user, said power control being electrically coupled to each of said air pump and said heat control, said power control de-actuating each of said air pump and said heat control when said power control is in an off condition, said power control actuating each of said air pump and said heat control when said power control is in an on condition; and
a power cord being coupled to and extending away from said air gun, said power cord being electrically coupled to said power control, said power cord having a distal end with respect to said air gun, said power cord having a male plug being electrically coupled to said distal end of said power cord thereby facilitating said male plug to be plugged into a power source comprising a female electrical outlet.

6. The assembly according to claim 2, wherein said latch is positioned on said barrel section of said air gun, said latch including a lever being pivotally coupled to said barrel section and a loop being movably coupled to said lever, said loop extending outwardly beyond said distal end of said barrel section, said loop being urged away from said distal end when said latch is in said releasing position, said loop being urged toward said distal end when said latch is in said engaging position.

7. The assembly according to claim 2, wherein:
each of said brush fittings has a first end, a second end and an outer wall extending between said first end and said second end, each of said first end and said second end being open, each of said brush fittings being hollow wherein each of said brush fittings is configured to pass air through said first end and said second end;
said outer wall has a first portion having a diameter being less than a diameter of a second portion, said first end being associated with said first portion, said second end being associated with said second end; and
said first portion is insertable into said distal end of said barrel section of said air gun having a threshold between said first portion and said second portion abutting said distal end of said barrel section.

8. The assembly according to claim 7, wherein:
said latch is positioned on said barrel section of said air gun, said latch including a lever being pivotally coupled to said barrel section and a loop being movably coupled to said lever, said loop extending outwardly beyond said distal end of said barrel section, said loop being urged away from said distal end when said latch is in said releasing position, said loop being urged toward said distal end when said latch is in said engaging position; and
each of said brush fittings has an engagement being coupled to said outer wall, said engagement being positioned adjacent to said threshold between said first portion and said second portion, said engagement having a recess integrated therein, said recess in said engagement of a respective brush fitting receiving said loop of said latch, said loop compressing said threshold of said respective brush fitting against said distal end of said barrel section when said latch is moved into said engaging position for retaining said respective brush fitting in said distal end.

9. The assembly according to claim 7, wherein said plurality of brush fittings includes a first brush fitting, a second brush fitting and a third brush fitting, said brushing elements associated with said first brush fitting comprising a plurality of first bristles each extending away from said second end of said first brush fitting, said first bristles being spaced apart from each other and being distributed around said second end of said first brush fitting, each of said first bristles being comprised of a resilient material wherein said plurality of first bristles is configured to dislodge dirt and debris from the golf shoes.

10. The assembly according to claim 9, wherein said brushing elements associated with said second brush fitting comprise a plurality of second bristles each extending away from said second end of said second brush fitting, said second bristles being spaced apart from each other and being distributed around said second end of said second brush fitting, each of said second bristles being comprised of a bendable material wherein said plurality of second bristles is configured to brush the golf shoes without abrading the golf shoes.

11. The assembly according to claim 9, wherein said second portion of said outer wall of said third brush fitting has a plurality of air holes each extending into an interior of said third brush fitting wherein each of said air holes is configured to direct air outwardly through said air holes.

12. The assembly according to claim 9, wherein said brushing elements associated with said third brush fitting comprise a plurality of lobes each being positioned on and extending outwardly from said outer wall associated with said second portion of said outer wall of said third brush fitting, said plurality of lobes being arranged into a plurality of rows each extending between said second end of said third brush fitting and said threshold of said third brush fitting, each of said lobes being comprised of a compressible textile material wherein each of said lobes is configured clean an upper of the golf shoes without abrading the upper of the golf shoes.

13. A golf shoe cleaning assembly for cleaning dirt and debris from golf shoes, said assembly comprising:
an air gun having an intake and an exhaust, said air gun having a barrel section and a grip section, said barrel section having a distal end with respect to said grip section, said distal end being open to define said exhaust, said grip section having a back end, said back end having a plurality of air holes each extending into an interior of said grip section to define said intake, said air gun having a conduit extending between said air holes and said distal end of said barrel section;
an air pump being positioned within said air gun wherein said air pump is configured to urge compressed air outwardly through said exhaust, said air pump having an input and an outlet, said air pump being fluidly coupled to said conduit such that said input is in fluid communication with said plurality of air holes and said output is in fluid communication with said distal end of said barrel section, said air pump urging air inwardly through said input and outwardly through said outlet when said air pump is turned on;
a heating unit being positioned within said air gun, said heating unit being in thermal communication with said exhaust wherein said heating unit is configured to heat air blown outwardly through said exhaust, said heating unit having an input and an outlet, said input of said heating unit being fluidly coupled to said conduit such that said input of said heating unit is in fluid communication with said outlet of said air pump and said outlet of said heating unit is in fluid communication with said distal end of said barrel section, said heating unit heating air urged outwardly through said outlet of said air pump when said heating unit is turned on;
a pressure control being movably integrated into said air gun wherein said pressure control is configured to be manipulated by a user, said pressure control being in communication with said air pump for adjusting an output of said air pump between a minimum output and a maximum output, said pressure control being electrically coupled to said air pump, said pressure control being positioned on a top side of said grip section of said air gun;
a heat control being movably integrated into said air gun wherein said heat control is configured to be manipulated by a user, said heat control being in communication with said heating unit for adjusting said heating unit between a minimum output and a maximum output, said heat control being electrically coupled to said heating unit, said heat control being positioned on a top side of said grip section of said air gun;
a power control being movably integrated into said air gun wherein said power control is configured to be manipulated by a user, said power control being electrically coupled to each of said air pump and said heat control, said power control de-actuating each of said air pump and said heat control when said power control is in an off condition, said power control actuating each of said air pump and said heat control when said power control is in an on condition;
a power cord being coupled to and extending away from said air gun, said power cord being electrically coupled to said power control, said power cord having a distal end with respect to said air gun, said power cord having a male plug being electrically coupled to said distal end of said power cord thereby facilitating said male plug to be plugged into a power source comprising a female electrical outlet;
a latch being movably integrated into said air gun, said latch being movable between an engaging position and a releasing position, said latch being positioned on said barrel section of said air gun, said latch including a lever being pivotally coupled to said barrel section and a loop being movably coupled to said lever, said loop extending outwardly beyond said distal end of said barrel section, said loop being urged away from said distal end when said latch is in said releasing position, said loop being urged toward said distal end when said latch is in said engaging position; and
a plurality of brush fittings, a respective one of said brush fittings being insertable into said exhaust of said air gun wherein each of said brush fittings is configured to receive the air from said air pump thereby facilitating said respective brush fitting to direct the air onto golf shoes for dislodging dirt and debris from the golf shoes, each of said brush fittings having a unique brushing element with respect to each other wherein said plurality of brush fittings is configured to perform a respective cleaning duty, each of said brush fittings having a first end, a second end and an outer wall extending between said first end and said second end, each of said first end and said second end being open, each of said brush fittings being hollow wherein each of said brush fittings is configured to pass air through said first end and said second end, said outer wall having a first portion having a diameter being less than a diameter of a second portion, said first end being associated with said first portion, said second end being associated with said second end, said first portion being insertable into said distal end of said barrel section of said air gun having a threshold between said first portion and said second portion abutting said distal end of said barrel section, each of said brush fittings having an engagement being coupled to said outer wall, said engagement being positioned adjacent to said threshold between said first portion and said second portion, said engagement having a recess integrated therein, said recess in said engagement of a respective brush fitting receiving said loop of said latch, said loop compressing said threshold of said respective brush fitting against said distal end of said barrel section when said latch is moved into said engaging position for retaining said respective brush fitting in said distal end, said plurality of brush fittings including a first brush fitting, a second brush fitting and a third brush fitting, said brushing elements associated with said first brush fitting comprising a plurality of first bristles each extending away from said second end of said first brush fitting, said first bristles being spaced apart from each other and being distributed around said second end of said first brush fitting, each of said first bristles being comprised of a resilient material wherein said plurality of first bristles is configured to dislodge dirt and debris from the golf shoes, said brushing elements associated with said second brush fitting comprising a plurality of second bristles each extending away from said second end of said second brush fitting, said second bristles being spaced apart from each other and being distributed around said second end of said second brush fitting, each of said second bristles being comprised of a bendable material wherein said plurality of second bristles is configured to brush the golf shoes without abrading the golf shoes, said second portion of said outer wall of said third brush fitting having a plurality of air holes each extending into an interior of said third brush fitting wherein each of said air holes is configured to direct air outwardly through said air holes, said brushing elements associated with said third brush fitting comprising a plurality of lobes each being positioned on and extending outwardly from said outer wall associated with said second portion of said outer wall of said third brush fitting, said plurality of lobes being arranged into a plurality of rows each extending between said second end of said third brush fitting and said threshold of said third brush fitting, each of said lobes being comprised of a compressible textile material wherein each of said lobes is configured clean an upper of the golf shoes without abrading the upper of the golf shoes.
